(19) United States
(12) Patent Application Publication
(10) Pub. No.: US 2025/0222966 A1
(43) Pub. Date: Jul. 10, 2025

(54) Foldable Transport Cart

(71) Applicants: Wendy Hinds, St Augustine, FL (US); David Halusky, Elkton, FL (US)

(72) Inventors: Wendy Hinds, St Augustine, FL (US); David Halusky, Elkton, FL (US)

(21) Appl. No.: 18/639,072

(22) Filed: Apr. 18, 2024

Related U.S. Application Data
(60) Provisional application No. 63/619,491, filed on Jan. 10, 2024.

(51) Int. Cl. B62B 1/12

(52) U.S. Cl. CPC B62B 1/12; B62B 2202/90; B62B 2501/065

(57) ABSTRACT

A foldable, wheeled cart has a first frame member having an upper portion and a lower portion joined by a pivot bore, a second frame member having an upper portion and a lower portion joined by a second pivot bore, with the first and second pivot bores aligned, a pivot pin passing through the first and the second pivot bores enabling the first frame member and the second frame member to be rotated relative to one another, and a first wheel attached pivotally to the first lower portion of the first frame member and a second wheel attached to the second lower portion of the second frame member. The first frame member and the second frame member may be rotated to create a V-shaped cradle for an object to be carried, which rotation also deploys the first and the second wheels to contact a support surface to carry the object.

### CROSS-REFERENCE TO RELATED APPLICATIONS

The instant application claims priority to Provisional Application 63/619,491 filed Jan. 10, 2024. All disclosure of the parent application is incorporated at least by reference.

### BACKGROUND OF THE INVENTION

### 1. Field of the Invention

The present invention is in the technical field of transporting apparatus and pertains more particularly to apparatus to aid kayak users in transporting kayaks, and many other things as well, over both indoor and outdoor surfaces.

### 2. Description of Related Art

Carriages, carts and trolleys with wheels to support kayaks, as well as other sorts of apparatus, in moving such apparatus over indoor and outdoor surfaces are well known in the art. One such is a cart provided by Suspenz, which may be seen at Suspenz.com. There are several others, and all of the conventional units have a commonality in that they are rather heavy and bulky and cannot be easily carried and deployed.

What is clearly needed is a simple, small and lightweight foldable and deployable wheeled cart that may easily be folded when not in use and carried in such a user's backpack or in the cockpit of the kayak or other boat.

### BRIEF SUMMARY OF THE INVENTION

In one embodiment of the invention a foldable, wheeled cart is provided, comprising a first frame member having a first upper portion and a first lower portion joined by a first pivot bore, a second frame member having a second upper portion and a second lower portion joined by a second pivot bore, with the first and second pivot bores aligned, a pivot pin passing through the first and the second pivot bores enabling the first frame member and the second frame member to be rotated relative to one another, a first wheel attached pivotally to the first lower portion of the first frame member and a second wheel attached to the second lower portion of the second frame member. The first frame member and the second frame member may be rotated to create a V-shaped cradle for an object to be carried, which rotation also deploys the first and the second wheels to contact a support surface to carry the object.

Also, in one embodiment the foldable, wheeled cart further comprises an angled extension on a lower extremity of the first upper portion placed to contact the second lower portion, constraining extent of rotation to form the V-shaped cradle. Also, in one embodiment the foldable, wheeled cart further comprises a plurality of slots in the first upper portion and in the second upper portion, facilitating use of straps and buckles holding an object in the V-shaped cradle. In one embodiment the foldable, wheeled cart further comprises a first opening in the first upper portion and a second opening in the second upper portion, the first and the second openings sized to admit a user's hand to carry the cart when folded closed. In one embodiment the first and the second frame member are formed from sheets of heat formable polymer, and in one embodiment the first and the second frame member are formed from sheets of metal.

In one embodiment the overall height of the cart folded closed is less than 13 inches, and in one embodiment the overall length of the cart in the direction of travel is less than 9 inches. In one embodiment the object is a kayak.

In another aspect of the invention a method for carrying an elongated object is provided, comprising forming a first frame member having a first upper portion and a first lower portion joined by a first pivot bore, forming a second frame member having a second upper portion and a second lower portion joined by a second pivot bore, with the first and second pivot bores aligned, passing a pivot pin passing through the first and the second pivot bores enabling the first frame member and the second frame member to be rotated relative to one another, attaching a first wheel pivotally to the first lower portion of the first frame member and a second wheel to the second lower portion of the second frame member, rotating the first frame member relative to the second frame member, forming a V-shaped cradle for an object to be carried, placing one end of the object into the V-shaped cradle, and supporting an end of the object away from the V-shaped cradle and pulling the object along supported on the wheels.

In one embodiment the method further comprises forming an angled extension on a lower extremity of the first upper portion, placed to contact the second lower portion, constraining extent of rotation to form the V-shaped cradle. Also, in one embodiment the method further comprises tying the object to the V-shaped cradle with belts through a plurality of slots in the first upper portion and in the second upper portion. Also, in one embodiment the method further comprises forming a first opening in the first upper portion and a second opening in the second upper portion, the first and the second openings sized to admit a user's hand to carry the cart when folded closed.

In one embodiment the method further comprises forming the first and the second frame member from sheets of heat formable polymer. Also, in one embodiment the method comprises forming the first and the second frame member from sheets of metal. In one embodiment of the method the overall height of the cart folded closed is less than 13 inches. And in one embodiment the overall length of the cart in the direction of travel is kept to less than 9 inches. In one embodiment of the method the object carried is a kayak.

### BRIEF DESCRIPTION OF THE SEVERAL VIEWS OF THE DRAWINGS

FIG. 1 is a perspective view of a foldable cart unfolded for use according to an embodiment of the present invention.

FIG. 2 is a perspective view of the foldable cart of FIG. 1 partly folded.

FIG. 3A is a perspective view of a first main frame portion of the foldable cart of FIG. 1.

FIG. 3B is a perspective view of a second main frame portion of the foldable cart of FIG. 1.

FIG. 4 is a side perspective view of the portion of FIG. 3A showing a short tubing as an axle housing.

### DETAILED DESCRIPTION OF THE INVENTION

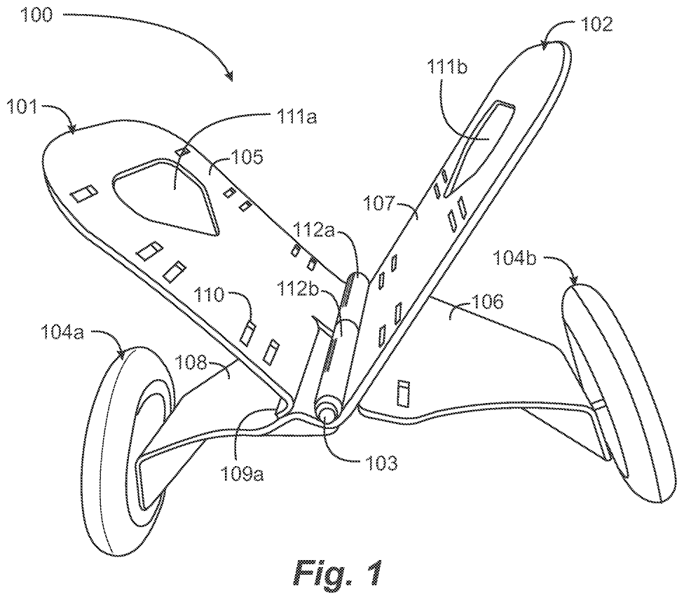

FIG. 1 is a perspective view of a foldable cart 100 in an unfolded aspect for use according to an embodiment of the present invention. Cart 100 comprises two frame structures 101 and 102, which are assembled together by a central pin 103 such that the two frame structures may be rotated relative to one another. Frame structure 101 has an upper region 105 on one side of pin 103 and a lower region 106 on the other side of pin 103. Similarly, frame structure 102 has an upper region 107 on one side of pin 103 and a lower region 108 on the other side of pin 103. The upper regions, when open as in FIG. 1, together form a V-shaped support for one end of a kayak or other object. Each lower region has a wheel attached in this example by a short axel and fasteners, wheel 104a to lower region 108 of structure 102 and wheel 104b to lower region 106 of structure 101. It is an important feature that when the upper regions 105 and 107 are brought together folding the kayak cart, lower regions 106 and 108 are also rotated inward to close proximity.

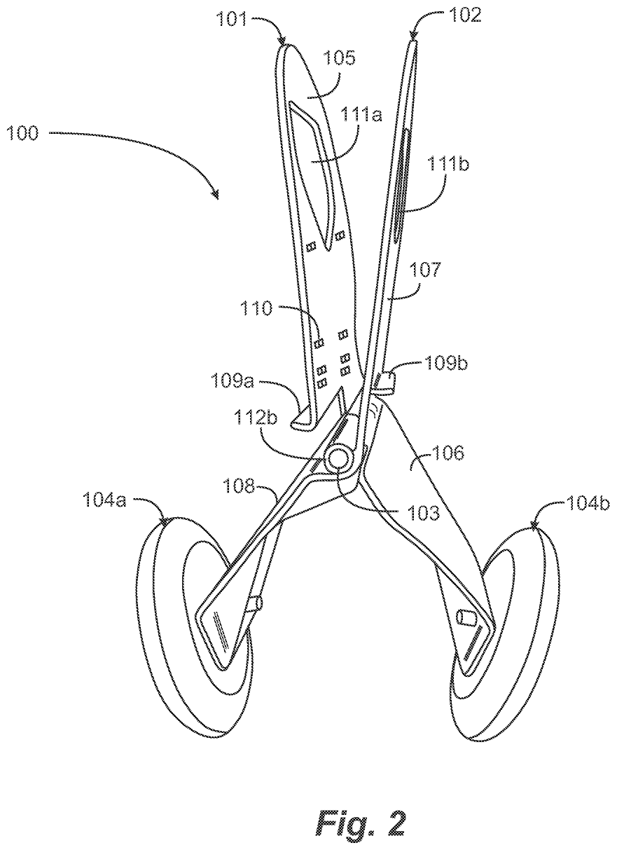

In use cart 100 is secured to one end of an object to be transported, such as a kayak, by belts with buckles, laced through rectangular openings, represented by opening 110, in each of the upper regions. The belts and buckles are not shown in FIGS. 1 and 2 to avoid occluding details of the structures. It may be seen In FIG. 1 that a lower edge 109a of upper region 105 of frame structure 101 is turned at an angle to form a stop that contacts a surface of lower region 108 as the cart is opened, preventing the frame structures from opening further. There is a similar turned edge 109b on upper region 107 of frame structure 102, not seen in FIG. 1, but evident in FIG. 2. In addition, there is a shaped opening 111a in upper region 105 of frame structure 101, and a similar opening 111b in upper region 107 of frame structure 102. These openings, with the cart folded closed, provide an opening for a user's hand to carry the kayak cart. A short tubing 102a is joined to frame structure 101 and a similar short tubing 112b is joined to frame structure 102 to provide a bore for accepting central pivot pin 103.

FIG. 2 is a perspective view of the foldable kayak cart of FIG. 1 folded nearly, but not completely, closed. It should be understood, however, that the finished cart is fully capable of being folded fully closed. All of the elements in FIG. 2 bear the same element numbers as in FIG. 1. As described above, as the cart is folded closed, the upper regions are brought together, and the lower regions with wheels are also brought together.

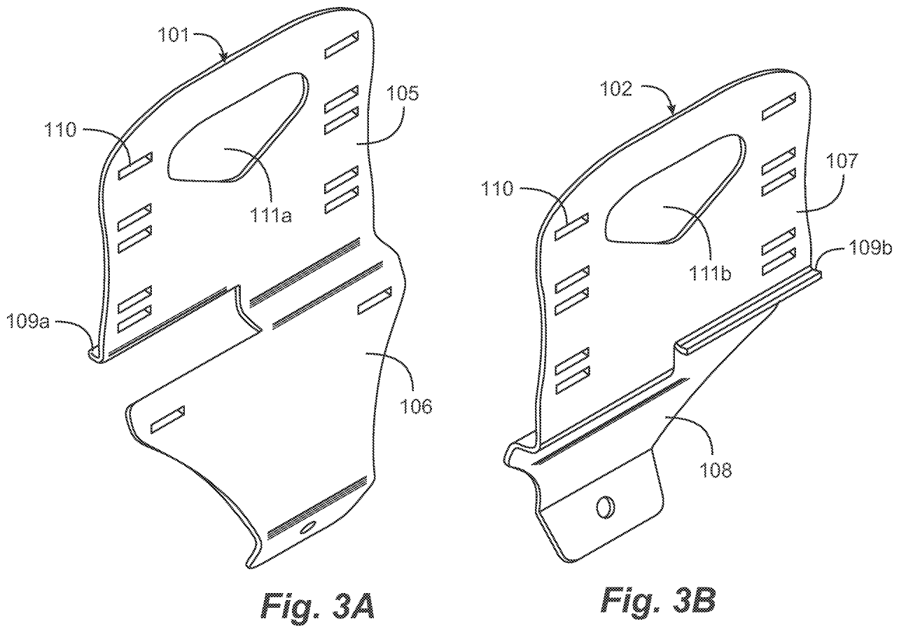

FIG. 3A is a perspective view of frame structure 101 with elements labeled the same as in FIGS. 1 and 2. FIG. 3B is a perspective view of frame structure 102 with elements labeled the same as in FIGS. 1 and 2. It should be evident to the skilled person that the frame structures may be produced in their final form by folding a flat sheet of metal or polymer material that has been machined to outer shape and to have the belt opening 110 and the hand openings 111a and 111b machined. The material may be preferably in one example a heat-formable plastic material.

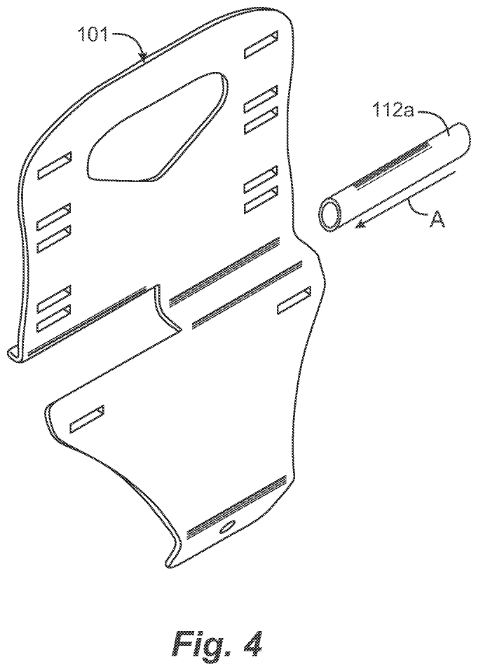

FIG. 4 illustrates frame structure 101 in perspective view and a short tubing 112a. One frame structure 101 is formed to shape, tubing 112a is moved in direction of arrow A and affixed, typically by an adhesive or by heating to structure 101. A short tubing 112b is added in similar fashion to frame structure 102. The two frame structures may then be pivotally joined by pin 103, which may have threaded ends and threaded caps for retention.

In one embodiment the overall height of the assembled Kayak cart, folded closed, is equal to or less than 12.75 inches, and the overall length is equal to or less than 8.75 inches, such that the folded cart is conveniently stored and carried in a user's backpack or in the cockpit of a kayak, which cannot be said for any carts in the prior art. Moreover, made of a plastic material, the weight is very small as well.

It should be understood as well that the foldable carta in embodiments of the invention is certainly not limited to use with kayaks but may be employed in moving other sorts of watercraft, and many other elements and apparatus as well. For example, a cart in an embodiment of the invention may be used with just about any elongated object or apparatus that fits within the V-shaped cradle of the deployed cart.

A person skilled in the art will understand that the embodiments described herein are entirely exemplary, and not limiting to the scope of the invention. The dimensions may vary under differing circumstances and there may be differences in shapes and functions in different embodiments as well. The scope of the invention is limited only by the claims that follow.

1. A foldable, wheeled cart, comprising:
a first frame member having a first upper portion and a first lower portion joined by a first pivot bore;
a second frame member having a second upper portion and a second lower portion joined by a second pivot bore;
with the first and second pivot bores aligned, a pivot pin passing through the first and the second pivot bores enabling the first frame member and the second frame member to be rotated relative to one another; and
a first wheel attached pivotally to the first lower portion of the first frame member and a second wheel attached to the second lower portion of the second frame member;
characterized in that the first frame member and the second frame member may be rotated to create a V-shaped cradle for an object to be carried, which rotation also deploys the first and the second wheels to contact a support surface to carry the object.

2. The foldable, wheeled cart of claim 1 further comprising an angled extension on a lower extremity of the first upper portion placed to contact the second lower portion, constraining extent of rotation to form the V-shaped cradle.

3. The foldable, wheeled cart of claim 1 further comprising a plurality of slots in the first upper portion and in the second upper portion, facilitating use of straps and buckles holding an object in the V-shaped cradle.

4. The foldable, wheeled cart of claim 1 further comprising a first opening in the first upper portion and a second opening in the second upper portion, the first and the second openings sized to admit a user's hand to carry the cart when folded closed.

5. The foldable, wheeled cart of claim 1 wherein the first and the second frame member are formed from sheets of heat formable polymer.

6. The foldable, wheeled cart of claim 1 wherein the first and the second frame member are formed from sheets of metal.

7. The foldable, wheeled cart of claim 1 wherein the overall height of the cart folded closed is less than 13 inches.

8. The foldable, wheeled cart of claim 1 wherein the overall length of the cart in the direction of travel is less than 9 inches.

9. The foldable, wheeled cart of claim 1, wherein the object is a kayak.

10. A method for carrying an elongated object, comprising:
forming a first frame member having a first upper portion and a first lower portion joined by a first pivot bore;
forming a second frame member having a second upper portion and a second lower portion joined by a second pivot bore;
with the first and second pivot bores aligned, passing a pivot pin passing through the first and the second pivot bores enabling the first frame member and the second frame member to be rotated relative to one another;
attaching a first wheel pivotally to the first lower portion of the first frame member and a second wheel to the second lower portion of the second frame member;
rotating the first frame member relative to the second frame member, forming a V-shaped cradle for an object to be carried;
placing one end of the object into the V-shaped cradle; and
supporting an end of the object away from the V-shaped cradle and pulling the object along supported on the wheels.

11. The method of claim 10 further comprising forming an angled extension on a lower extremity of the first upper portion, placed to contact the second lower portion, constraining extent of rotation to form the V-shaped cradle.

12. The method of claim 10 further comprising tying the object to the V-shaped cradle with belts through a plurality of slots in the first upper portion and in the second upper portion.

13. The method of claim 10 further comprising forming a first opening in the first upper portion and a second opening in the second upper portion, the first and the second openings sized to admit a user's hand to carry the cart when folded closed.

14. The method of claim 10 comprising forming the first and the second frame member from sheets of heat formable polymer.

15. The method of claim 10 comprising forming the first and the second frame member from sheets of metal.

16. The method of claim 10 comprising constraining the overall height of the cart folded closed to less than 13 inches.

17. The method of claim 10 comprising constraining the overall length of the cart in the direction of travel to less than 9 inches.

18. The method of claim 10 wherein the object is a kayak.
